(19) United States
(12) Patent Application Publication
(10) Pub. No.: US 2020/0046149 A1
(43) Pub. Date: Feb. 13, 2020

(54) NON-SEWN DOWN BEDDING AND MANUFACTURING METHOD THEREOF

(71) Applicant: E-DUCK INC., Goyang-si, Gyeonggi-do (KR)

(72) Inventor: NAKYEONG LEE, Incheon (KR)

(21) Appl. No.: 16/071,706

(22) PCT Filed: Feb. 12, 2018
(86) PCT No.: PCT/KR2018/001789

§ 371 Date: Jul. 20, 2018

(30) Foreign Application Priority Data
Mar. 14, 2017 (KR) 10-2017-0031767

(51) Int. Cl. A47G 9/02; B68G 1/00; B68G 7/10; B68G 7/12; B68G 7/06

(52) U.S. Cl. CPC A47G 9/0207; B68G 1/00; B68G 7/10; B68G 2001/005; A47G 9/0238; B68G 7/06; B68G 7/12

(57) ABSTRACT

The present invention relates to non-sewn down bedding including a partition wall provided with a unique non-sewn partition wall member and an edge portion finished to have a special structure, thereby greatly simplifying the bedding manufacturing process, reducing costs and improving productivity while inhibiting down from escaping through the edge portion. Therefore, the quality of a finished product may be very high. A non-sewn bedding item according to the present invention includes a bedding outer cover having an upper fabric and a lower fabric, the upper fabric and the lower fabric defining an inner space, a partition wall member configured to divide the inner space into a plurality of compartment spaces such that each of the compartment spaces is filled with down, the partition wall allowing air to flow between the compartment spaces and restricting movement of the down between the compartment spaces, and an edge finish portion formed at an edge of the bedding item to inhibit the down from escaping from each of the compartment spaces.

### TECHNICAL FIELD

The present invention relates to bedding such as a duvet, a pillow, a cushion or a rug filled with feathers such as duck down or goose down. Specifically, the present invention relates to a manufacturing method of non-sewn down bedding with a minimized sewing part for improving productivity and down bedding manufactured thereby.

### BACKGROUND ART

Lightweight, highly thermally insulating feather bedding or so-called goose down or duck down bedding (hereinafter “down bedding”), which is superior to conventional bedding such as a duvet, a pillow, a cushion, and a rug filled with cotton or chemical cotton, is widely used.

Conventionally, in order to prevent the cotton filling the inside of the outer fabric from being shifted or maldistributed to one side, the duvet is manufactured by filling the wide area of the outer fabric with cotton and then sewing the outer fabric horizontally and vertically so as to form a large number of compartment spaces, which is a relatively easy task. However, for the down bedding, which is manufactured by filling the inside of the outer fabric with feathers (down) such as goose down or duck down, the down is likelier to be scattered more than the conventional cotton, and thus likelier to be shifted or maldistributed to one side in the outer fabric. In addition, the down is has low density, and each strip of down serves as an independent heat-insulating material. Accordingly, it is difficult in terms of productivity to manufacture a duvet by forming compartment spaces by sewing after filling the outer fabric with down.

In order to overcome such a problem in manufacturing down bedding, a plurality of compartment spaces is formed first by sewing the outer fabric horizontally and vertically before the outer fabric is filled with down, and then each compartment space is filled with down. In addition, during use of the down bedding, the stitches of the sewn parts may be widened or opened, and the down inside the fabric may become smaller. Thereby, the down can escape through the stitch holes. Therefore, a measure should be taken to prevent such events.

As manufacture of bedding described above requires formation of a plurality of compartment spaces, filling of each compartment space with down and an operation for preventing the down from escaping, manufacturing costs of the bedding may increase, productivity may decrease, and quality assurance requirements may become more complex.

In filling the down bedding with down, down contained in a down container for distribution is injected into the bedding by blowing compressed air generated by a compressor through an injection rod.

### DISCLOSURE

### Technical Problem

Therefore, the present invention has been made in view of the above problems, and it is one object of the present invention to provide a method of manufacturing non-sewn bedding by employing a new material and a new process step and down bedding manufactured thereby.

### Technical Solution

In accordance with one aspect of the present invention, provided is a non-sewn down bedding item including a bedding outer cover having an upper fabric and a lower fabric, the upper fabric and the lower fabric defining an inner space, a partition wall member configured to divide the inner space into a plurality of compartment spaces such that each of the compartment spaces is filled with down, the partition wall allowing air to flow between the compartment spaces and restricting movement of the down (feathers) between the compartment spaces, and an edge finish portion formed at an edge of the bedding item to prevent the down from escaping from each of the compartment spaces,

Here, the partition wall member includes first and second single-sided adhesive tapes respectively sewn to both longitudinal edges of a mesh strip having a width W allowing air to pass therethrough and preventing the down from passing therethrough, the first and second single-sided adhesive tapes each having a width of less than half the width W, wherein adhesive surfaces of the single-sided adhesive tapes are sewn to the mesh strip so as to face away from the mesh strip, and a mesh strip portion is folded by a hot press along an imaginary longitudinal center line of the mesh strip in a longitudinal direction so as to have a substantial width We less than the width W of the mesh strip and remains not bonded to the single-sided adhesive tapes. Thus, the adhesive surfaces of the single-sided adhesive tapes sewn to the mesh strip folded in the longitudinal direction are attached to the upper fabric and the lower fabric, respectively. Thereby, a structure capable of making the volume of the compartment space 15 as large as possible and allowing smooth communication of air while preventing the goose down from moving between the compartment spaces is implemented.

An intersection portion of the partition wall members is formed by further forming, on a longitudinal center line of the partition wall member, a cutaway portion having a length of W/2 greater than equal to a width W/2 obtained by folding the mesh strip of the width W in the longitudinal direction and inserting a separate partition wall member into the cutaway portion.

In addition, the edge finish portion includes a thermally melting reinforcing tape interposed between and attached to the upper fabric and the lower fabric by being heated by a press, and a liner sewn by wrapping outer surfaces of the upper fabric and the lower fabric, with margins being formed by folding longitudinal opposite sides of the upper fabric and the lower fabric inward, the margins contacting the upper fabric and the lower fabric.

In accordance with another aspect of the present invention, provided is a method of manufacturing a non-sewn down bedding item having the above-described structure. This method is implemented in the following process:

1. A partition wall manufacturing step of sewing first and second single-sided adhesive tapes each having a length less than W/2 to both longitudinal edges of a mesh strip having a width W allowing air to pass therethrough and preventing the down from passing therethrough with adhesive surfaces thereof facing away from the mesh strip (29) and folding the mesh strip (29) along the longitudinal center line (35) of the mesh strip (29) in the longitudinal direction by hot press;

2. A step of laying the lower fabric on an iron worktable and arranging the manufactured partition member longitudinally and laterally on the lower fabric to prepare to form compartment spaces;

3. A step of arranging a thermally melting reinforcing tape on an edge portion of the lower fabric and covering the same with the upper fabric;

4. A step of attaching the adhesive tapes of the partition wall member and the thermally melting reinforcing tape of the edge portion to the upper fabric and the lower fabric using a press, wherein the thermally melting reinforcing tape of the edge portion is not entirely pressed by the press, and an injection opening portion for injecting the down into each of the compartment spaces is left,

5. A step of forming an edge finish portion by arranging a liner so as to wrap both the upper fabric and the lower fabric of the edge portion including the thermally melting reinforcing tape interposed between and attached to the upper fabric and the lower fabric, the liner being sewn with longitudinal opposite sides of the liner folded inward such that margins to contact the upper fabric and the lower fabric are formed, wherein an entirety of the edge portion is not sewn, but an injection opening for injecting the down into each of the compartment spaces is left open;

6. A step of inserting an injection rod into the injection opening and injecting the down into each of the compartment spaces divided by the partition wall member through the injection rod; and

7. A step of melting the thermally melting reinforcing tape by pressing with a press to close the injection opening and complete sewing of the liner.

In accordance with yet another aspect of the present invention, provided is a structure of the partition wall member described above, a manufacturing method thereof, and a structure of the edge finish portion and a manufacturing method thereof.

The configuration and operation of the present invention described above will be clarified through specific embodiments to be described later with reference to the drawings.

### Advantageous Effects

According to the present invention, since a partition wall of the down bedding is provided with a unique non-sewn partition wall member and an edge portion of the bedding is finished to have a special structure, the bedding manufacturing process may be greatly simplified, costs may be reduced and productivity may be improved. In addition, down may be prevented from escaping through the edge portion. Therefore, the quality of a finished product may be very high.

### DESCRIPTION OF DRAWINGS

FIG. 1 is a perspective view of an entire structure of a goose down duvet 100 according to an embodiment of the present invention;

FIG. 2 is a cross-sectional view taken along line A-A in FIG. 1;

FIG. 3 shows a partition wall member 25 constituting a partition wall;

FIG. 4 is a view illustrating operation of the partition wall member 25;

FIG. 5 shows an intersection portion of the partition wall member 25;

FIG. 6 shows an edge finish portion 17 of FIG. 1; and

FIGS. 7 to 9 illustrate an embodiment of a method of manufacturing a non-sewn goose down duvet.

Goose down duvet 100, Upper fabric 19, Lower fabric 21, Longitudinal partition wall 11, Transverse partition wall 13, Compartment space 15, Goose down 23, Edge finish portion 17, Partition wall member 25, Air flow 27, Mesh strip 29, Adhesive tape 31a, 31b, Adhesive surface 33a, 33b, Stitch 34a, 34b, Center line 35, Cutaway portion 37, Gap 38a, 38b, Reinforcing tape 39, Liner 41, the margins 43a, 43b, Sewing line 45, Iron worktable 47, Magnet 49, Injection opening 51

### BEST MODE FOR CARRYING OUT THE INVENTION

Hereinafter, a non-sewn goose down duvet and a manufacturing method for the same according to an embodiment of the present invention will be described in detail with reference to the drawings.

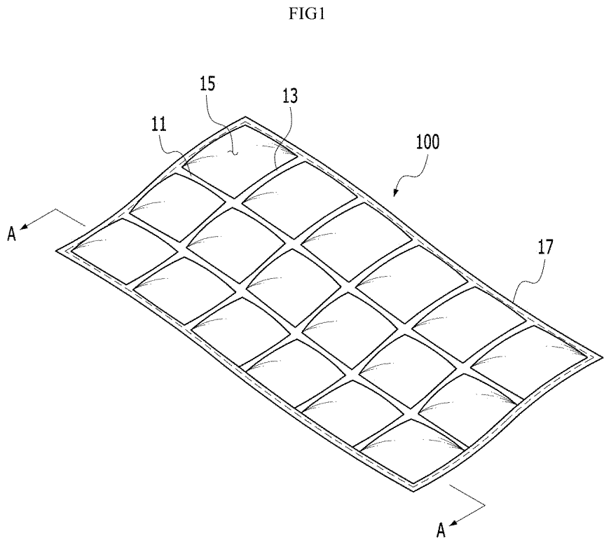

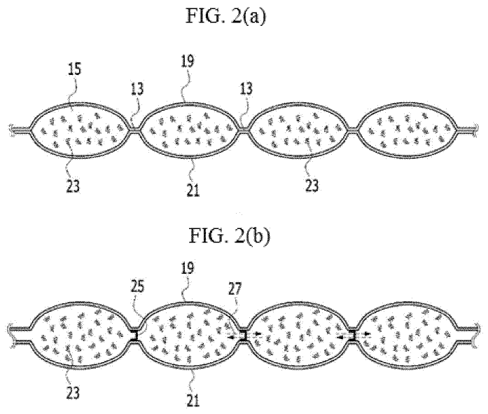

FIG. 1 is a perspective view of an entire structure of a goose down duvet 100 according to an embodiment of the present invention, and FIG. 2 is a cross-sectional view taken along line A-A in FIG. 1.

Basically, the duvet 100 of this embodiment includes an upper fabric (19 in FIG. 2) and a lower fabric (21 in FIG. 2), which form an outer cover so as to define an inner space. The duvet 100 is provided with a plurality of compartment spaces 15 defined by a longitudinal partition wall 11 and a transverse partition wall 13. Each of the compartment spaces 15 is independently filled with goose down 23 injected thereinto through a down injection rod (not shown). An edge finish portion 17 is formed at the edges of the four sides of the duvet 100.

The cross-sectional views of FIGS. 2(a) and 2(b) taken along line A-A show an upper fabric 19, a lower fabric 21, compartment spaces 15, a partition wall (particularly, a transverse partition wall) 13, and goose down 23. Here, the partition walls 11 and 13 are structurally formed such that the upper fabric 19 and the lower fabric 21 are not fully attached to each other. That is, the partition walls 11 and 13 are not formed so as to completely separate the compartment spaces 15 from each other. If the upper fabric 19 and the lower fabric 21 are fully attached to each other, air cannot pass between the compartment spaces 15, and the duvet becomes thin due to the partition walls 11 and 13. Thereby, the volume of the interior of the compartment space 15 becomes small and the function of the goose down duvet is greatly deteriorated. There is a need for a structure capable of making the volume of the compartment space 15 as large as possible and allowing smooth communication of air while preventing the goose down from moving between the compartment spaces 15.

This necessity is illustrated in FIG. 2(b). In other words, the partition wall (13 in FIG. 2) between the upper fabric 19 and the lower fabric 21 may be implemented using a partition wall member 25 having a special structure. The partition wall member 25 is formed to ensure smooth communication of air while preventing movement of the goose down 23 and widening each compartment space 15 as much as possible.

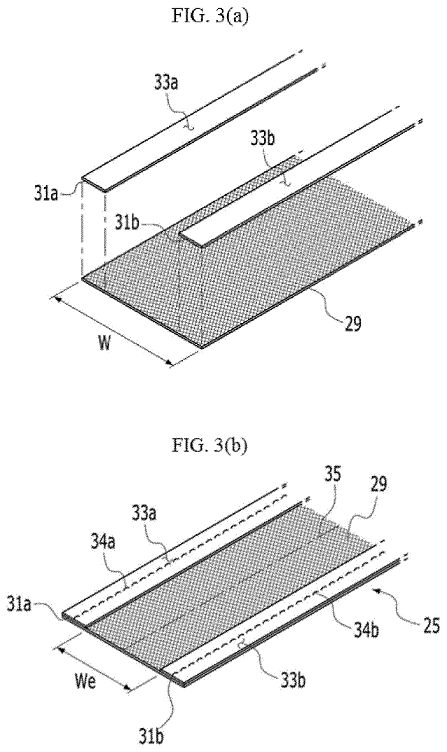

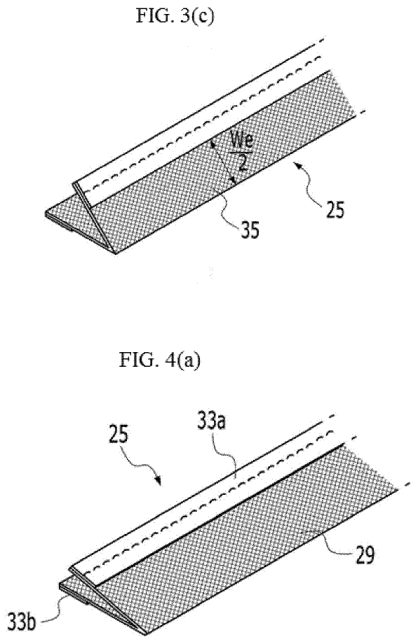

FIGS. 3(a), 3(b) and 3(c) show the partition wall member 25 constituting the partition wall for this purpose.

As shown in FIG. 3(a), single-sided adhesive tapes 31a and 31b having a width of about 1 cm are bonded to the longitudinal edges of a mesh strip 29 having a width W (=about 4 cm). In bonding the tapes, the adhesive surfaces 33a and 33b of the adhesive tapes 31a and 31b are arranged to face away from the mesh strip 29. The bonding may be performed through stitching or the like.

As a result of the bonding by stitching, the partition wall member 25 as shown in FIG. 3(b) is completed. Here, stitches 34a and 34b, which are formed by stitching the single-sided adhesive tapes 31a and 31b onto the longitudinal edges of both sides of the mesh strip 29, can be seen. The center line 35 marked in the longitudinal direction of the mesh strip 29 is an imaginary line along which the mesh strip is to be folded in the longitudinal direction and will be described in detail in FIG. 3(c). In FIG. 3(b), in addition to the width W of the mesh strip, a substantial width We of a part of the mesh strip to which the single-sided adhesive tapes 31a and 31b are not bonded is defined, which indicates the maximum spacing between the upper fabric 19 and the lower fabric 21.

FIG. 3(c) shows the partition wall member 25 folded along the longitudinal center line 35 of the mesh strip 29 in the longitudinal direction. Folding may be carried out by various processes, and may be easily folded using a press or the like. Therefore, a material capable of substantially maintaining a folded shape after being folded by the press may be selected as a material of the mesh strip. For example, a mesh strip of the so-called “75/20 Smith Kang” resin sold in a roll form may be used. For reference, a product named “SEAM TAPE (WPS2)”, which is used for non-sewn bonding of fabrics, may be employed as the single-sided adhesive tapes 31a and 31b.

Although the partition wall member 25 shown in FIG. 3(c) is the final complete form, the actual manufacturing process of the partition wall member 25 is not carried out in the order of FIGS. 3(a) to 3(c). For example, the mesh strip 29 may be folded along the center line 35 in the longitudinal direction first before the single-sided adhesive tapes 31a and 31b are bonded. That is, the mesh strip 29 unreeled from a supplied roll is passed through a roller press in a folded state via a bias binder (which serves to fix the cut fabric during stitching) so as to be folded in half. Then, the folded mesh strip 29 and the two single-sided adhesive tapes 31a and 31b may be automatically stitched together through the bias binder. The partition wall member 25 may be manufactured through various processes using various kinds of tools available in the art.

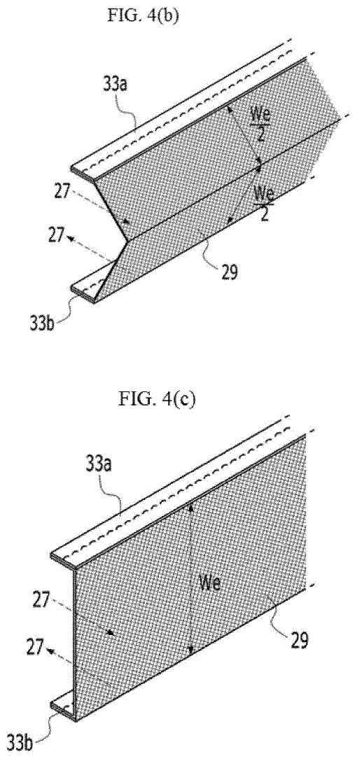

FIG. 4 is a view illustrating operation of the partition wall member 25.

As shown in FIG. 4(a), the partition wall member 25 is formed such that the adhesive surfaces 33a and 33b, which are arranged to face upward and downward in opposite directions, are attached to the upper fabric 19 and the lower fabric 21 to form respective partition walls 11 and 13 shown in FIG. 1. Attaching the adhesive surfaces 33a and 33b of the single-sided adhesive tapes 31a and 31b to the upper fabric 19 and the lower fabric 21 may be implemented by, for example, a hot press. This figure shows the partition wall member 25 arranged with the upper fabric 19 and the lower fabric 21 positioned close thereto as shown in FIG. 2(a).

FIG. 4(b) shows the shape of the partition wall member 25 formed when the upper fabric 19 and the lower fabric 21 are moved away from each other and thus the compartment space 15 is widened as shown in FIG. 2(b). Since the adhesive surfaces 33a and 33b of the single-sided adhesive tapes 31a and 31b facing upward and downward are attached to the upper fabric 19 and the lower fabric 21, respectively, parts of the mesh strip each having a width equal to half the substantial width We, which is less than the original width W of the mesh strip 29 by the width of the single-sided adhesive tape 31a, 31b, are vertically stretched out. In the figure, reference numeral 27 means that air flows through the mesh strip 29. On the other hand, the goose down cannot move therethrough.

FIG. 4(c) shows the partition wall member 25 that is opened to the maximum degree. As the mesh strip 19 is opened as wide as the substantial width we, the upper fabric 19 and the lower fabric 21 are at the farthest distance from each other.

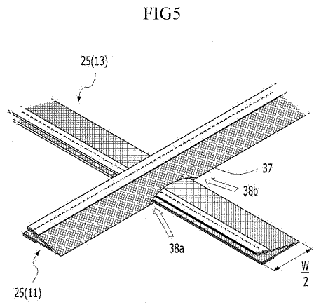

FIG. 5 shows an intersection portion of the partition wall member 25. The same effect as obtained at other points should be obtained at the intersection of the longitudinal partition wall 11 and the transverse partition wall 13. That is, air should be allowed to flow, while movement of the goose down should be prevented, and expansion of the compartment space 15 should be allowed. Also, when the finished duvet product is viewed from the outside, the intersection portion should not be abnormally expanded.

In forming the intersection portion of the partition wall member 25, a cutaway portion 37 whose length is (or is slightly greater than) approximately W/2 (that is, a width obtained when the mesh strip of width W is folded lengthwise) is formed on the longitudinal center line of the partition wall member 25 of one of the longitudinal partition wall 11 and the transverse partition wall 13, and the other partition wall member 25 is inserted into the cutaway portion 37. Since the mesh strip is formed of a flexible cloth material, the width of the cutaway portion 37 does not matter if the length of the cutaway portion 37 is slightly greater than or equal to approximately W/2. After one partition wall member 25 is arranged to intersect the other partition wall member 25 through the cutaway portion 37 of the other partition wall member 25, a goose down injection rod (not shown) is inserted into the gaps 38a and 38b at both ends of the cutaway portion 37 and goose down is injected into the corresponding compartment space 15 therethrough, as shown FIG. 5.

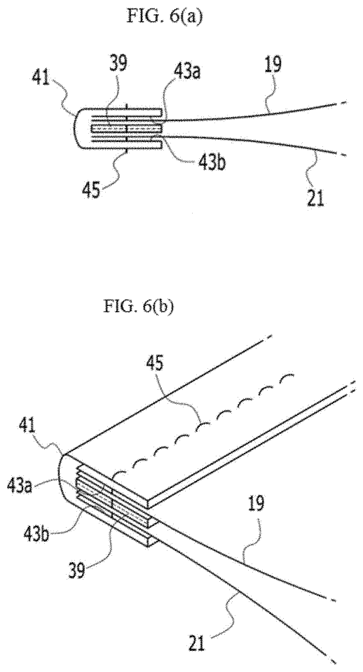

FIG. 6 shows the structure of the edge finish portion 17 of FIG. 1.

As the use period of the duvet increases, the goose down escapes through the stitches more and more often. In order to prevent this event, the periphery of the edges of the duvet 100 must be tightly closed. In the present invention, the edge finish portion 17 is formed in the structure as shown in FIG. 6. A thermally melting reinforcing tape 39, which is melted by heat and absorbed into the tissue, is inserted into the gap between the upper fabric 19 and the lower fabric 21 and is heated and bonded by a press, and the outer surface is wrapped with a separate liner 41 and is stitched. Here, the liner 41 is stitched with margins 43a and 43b formed by folding the opposing longitudinal sides of the liner 41 inward. FIGS. 6(a) and 6(b) show a sewing line 45 formed by stitching the upper fabric 19, the lower fabric 21, the thermally melting reinforcing tape 39, and both side margins 43a and 43b of the liner together.

Here, a product called “Magician Web Adhesive” was used as the thermally melting reinforcing tape. This product is widely used for pants hemming and is approximately 1.2 cm wide. As the liner 41, various materials such as fabric or non-fabric may be used. In the present invention, fabric diagonally cut with respect to the weft and warp directions and rolled up is used as the liner 41.

### DETAILED DESCRIPTION OF THE INVENTION

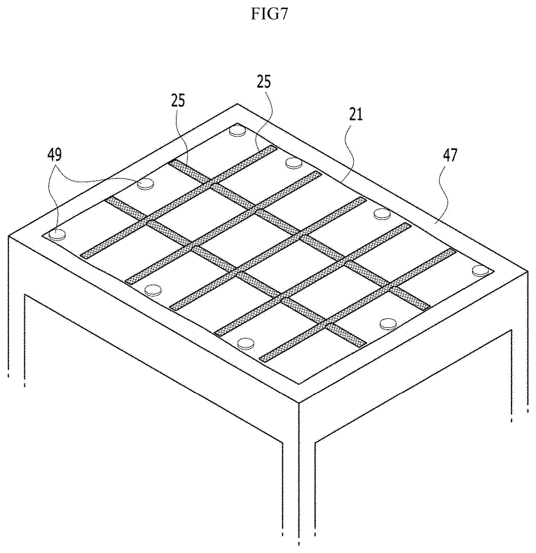

Hereinafter, a method of manufacturing a non-sewn goose down duvet according to an embodiment of the present invention will be described with reference to FIGS. 7 to 9.

First, the material is line-processed. The object subjected to line processing is the partition wall member 25 of FIG. 3. If necessary, abutting line sewing may be performed on each of the upper fabric 19 and the lower fabric 21. Of course, this operation is not needed for fabric materials that do not require abutting line sewing. Further, the intersection cutaway portion 37 of the partition wall member 25 may also be performed during line processing. The position of the intersection cutaway portion 37 of the partition wall member is set by the preliminary design of the partition wall.

With the partition wall member 25 line-processed, the (line-joined or integrated) lower fabric 21 is laid on an iron worktable 47 and the peripheral portions thereof are fixed with a magnet 49. Then, the line-processed partition wall member 25 is longitudinally and laterally arranged on the lower fabric 21 to prepare to form the longitudinal partition wall (11 of FIG. 1) and the transverse partition wall (13 of FIG. 1). The process up to this operation is illustrated in FIG. 7.

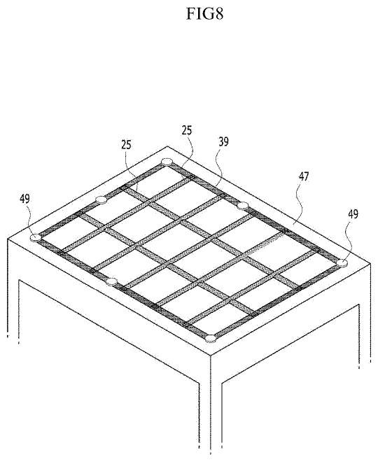

After the partition wall members 25 are positioned, the thermally melting reinforcing tape 39 is placed at the edge position, and then both ends and edges of each tape are fixed with the magnet 49. Finally, the upper fabric 19 is placed on top. FIG. 8 shows parts immediately before being covered by the upper fabric 19.

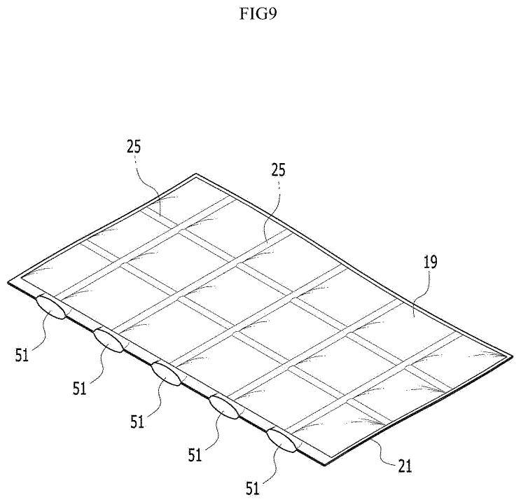

After the upper fabric 19 is placed on top, the magnet 49 is removed, and the adhesive tape (31a and 31b in FIGS. 3 and 4) of the partition wall member 25 and the thermally melting reinforcing tape (39 in FIG. 6) of the edge finish portion (17 in FIG. 1) are fixed in place by ironing, and then the upper fabric 19 and the lower fabric 21 are completely bonded by pressing in a press. However, at this time, the thermally melting reinforcing tape of the edge portion is not entirely pressed by the press in order to leave an injection opening portion (51 in FIG. 9) into which an injection rod (not shown) is to be inserted. In FIG. 9, the injection window 51 is shown.

Next, the edge finish portion (17 in FIG. 1) is formed by sewing the edge portion with a liner (41 in FIG. 6) having a predetermined width (for example, 2.5 cm) as shown in FIG. 6. In sewing the liner, for example, a 1/16 inch stitch bias binder may be utilized. However, sewing should be performed with the goose down injection opening portion 51 preserved.

An injection rod is inserted into the preserved injection opening 51 and a predetermined amount of goose down measured by an electronic balance is injected into each of the compartment spaces 15 divided by the partition walls to fill the space. The injection rod may be inserted into each compartment space 15 through the gaps 38a and 38b at both ends of the cutaway portion 37 at the intersection portion of the partition wall members 25 as shown in FIG. 5.

Finally, after filling with the goose down, the thermally melting reinforcing tape 39 (FIG. 6) is melted by pressing with the press to close each injection opening 51, and the liner 41 is finally sewn as shown in FIG. 6 to complete the duvet of the present invention.

### APPLICABILITY

The non-sewn down bedding and manufacturing method can be used in related industries by producing a non-sewn down bedding that greatly simplifies the bedding production process, reduces the cost, and improves the productivity.

1. A non-sewn down bedding item comprising:
a bedding outer cover having an upper fabric and a lower fabric, the upper fabric and the lower fabric defining an inner space;
a partition wall member configured to divide the inner space into a plurality of compartment spaces such that each of the compartment spaces is filled with down, the partition wall allowing air to flow between the compartment spaces and restricting movement of the down between the compartment spaces; and
an edge finish portion formed at an edge of the bedding item to inhibit the down from escaping from each of the compartment spaces,
wherein the partition wall member comprises:
first and second single-sided adhesive tapes (31a, 31b) respectively sewn to both longitudinal edges of a mesh strip having a width W allowing air to pass therethrough and inhibiting the down from passing therethrough, the first and second single-sided adhesive tapes each having a width of less than half the width W; and
a mesh strip portion folded by a hot press along a longitudinal center line (35) of the mesh strip (29) in a longitudinal direction so as to have a substantial width We less than the width W of the mesh strip and remaining not bonded to the single-sided adhesive tapes (31a, 31b),
wherein adhesive surfaces (33a, 33b) of the single-sided adhesive tapes (31a, 31b) sewn to the mesh strip (29) folded by the hot press in the longitudinal direction face away from the mesh strip (29) so as to be attached to the upper fabric and the lower fabric, respectively,
wherein the edge finish portion comprises:
a thermally melting reinforcing tape (39) interposed between and attached to the upper fabric and the lower fabric by being heated by a press; and
a liner (41) sewn by wrapping outer surfaces of the upper fabric and the lower fabric, with margins (43a, 43b) being formed by folding longitudinal opposite sides of the upper fabric and the lower fabric inward, the margins (43a, 43b) contacting the upper fabric and the lower fabric.

2. The down bedding item according to claim 1, wherein the partition wall member further comprises:
a cutaway portion (37) having a length greater than or equal to a width W/2 obtained by folding the mesh strip of the width W in the longitudinal direction, the cutaway portion (37) being arranged on a longitudinal center line of the partition wall member,
wherein a separate partition wall member is inserted into the cutaway portion (37).

3. A method of manufacturing the non-sewn down bedding item according to claim 1, comprising:
a partition wall manufacturing step of sewing first and second single-sided adhesive tapes (31a, 31b) each having a length less than W/2 to both longitudinal edges of a mesh strip having a width W allowing air to pass therethrough and inhibiting the down from passing therethrough with adhesive surfaces (33a, 33b) thereof facing away from the mesh strip (29) and folding the mesh strip (29) along the longitudinal center line (35) of the mesh strip (29) in the longitudinal direction by hot press;
laying the lower fabric on an iron worktable and arranging the manufactured partition member longitudinally and laterally on the lower fabric to prepare to form compartment spaces;
arranging a thermally melting reinforcing tape on an edge portion of the lower fabric and covering the same with the upper fabric;
attaching the adhesive tapes of the partition wall member and the thermally melting reinforcing tape of the edge portion to the upper fabric and the lower fabric using a press, wherein the thermally melting reinforcing tape of the edge portion is not entirely pressed by the press, and an injection opening portion for injecting the down into each of the compartment spaces is left;
forming an edge finish portion by arranging a liner so as to wrap both the upper fabric and the lower fabric of the edge portion including the thermally melting reinforcing tape interposed between and attached to the upper fabric and the lower fabric, the liner being sewn with longitudinal opposite sides of the liner folded inward such that margins to contact the upper fabric and the lower fabric are formed, wherein an entirety of the edge portion is not sewn, but an injection opening for injecting the down into each of the compartment spaces is left open;
inserting an injection rod into the injection opening and injecting the down into each of the compartment spaces divided by the partition wall member through the injection rod; and
melting the thermally melting reinforcing tape by pressing with a press to close the injection opening and complete sewing of the liner.

4. A method of manufacturing the non-sewn down bedding item according to claim 2, comprising:
a partition wall manufacturing step of sewing first and second single-sided adhesive tapes (31a, 31b) each having a length less than W/2 to both longitudinal edges of a mesh strip having a width W allowing air to pass therethrough and inhibiting the down from passing therethrough with adhesive surfaces (33a, 33b) thereof facing away from the mesh strip (29) and folding the mesh strip (29) along the longitudinal center line (35) of the mesh strip (29) in the longitudinal direction by hot press;
laying the lower fabric on an iron worktable and arranging the manufactured partition member longitudinally and laterally on the lower fabric to prepare to form compartment spaces;
arranging a thermally melting reinforcing tape on an edge portion of the lower fabric and covering the same with the upper fabric;
attaching the adhesive tapes of the partition wall member and the thermally melting reinforcing tape of the edge portion to the upper fabric and the lower fabric using a press, wherein the thermally melting reinforcing tape of the edge portion is not entirely pressed by the press, and an injection opening portion for injecting the down into each of the compartment spaces is left;
forming an edge finish portion by arranging a liner so as to wrap both the upper fabric and the lower fabric of the edge portion including the thermally melting reinforcing tape interposed between and attached to the upper fabric and the lower fabric, the liner being sewn with longitudinal opposite sides of the liner folded inward such that margins to contact the upper fabric and the lower fabric are formed, wherein an entirety of the edge portion is not sewn, but an injection opening for injecting the down into each of the compartment spaces is left open;
inserting an injection rod into the injection opening and injecting the down into each of the compartment spaces divided by the partition wall member through the injection rod; and
melting the thermally melting reinforcing tape by pressing with a press to close the injection opening and complete sewing of the liner.
